(19) United States
(12) Patent Application Publication
(10) Pub. No.: US 2013/0287901 A1
(43) Pub. Date: Oct. 31, 2013

(54) Fortune T

(71) Applicant: John J. Hong, Chicago, IL (US)

(72) Inventor: John J. Hong, Chicago, IL (US)

(21) Appl. No.: 13/863,054

(22) Filed: Apr. 15, 2013

Related U.S. Application Data
(60) Provisional application No. 61/624,095, filed on Apr. 13, 2012.

(51) Int. Cl. A47G 19/16; A23F 3/18; B65D 85/812

(52) U.S. Cl. CPC A47G 19/16; B65D 85/812; A23F 3/18
USPC 426/83; 426/232; 99/316

(57) ABSTRACT

A tea bag and a method and apparatus for its use are disclosed. Generally speaking the tea bag comprises an indicia that is selectively visible based on a desired characteristic of a tea-based beverage brewed from the tea bag. In various exemplary embodiments, the indicia indicates an elapsed time that the beverage has been brewed. In various other exemplary embodiments, the indicia indicates a relative strength of the brewed beverage. In yet other exemplary embodiments, the indicia indicates a temperature of the brewed beverage.

### RELATED APPLICATIONS

This application is a continuation of, and claims filing priority to, U.S. Provisional Patent Application Ser. No. 61/624,095 titled “Fortune Tea” by John Hong, filed Apr. 13, 2012, the entire contents of which is hereby specifically incorporated by reference in its entirety.

### BACKGROUND OF THE INVENTION

1. Field of the Invention

This invention is related to beverages. This invention is more specifically related to beverages made from tea leaves and apparatuses for their brewing.

2. Related Art

Tea-based beverages are typically made by brewing tea leaves in water. The tea leaves may be whole, chopped, cut, or in any other suitable shape. Typically, a user submerges the tea leaves in water for a period of time and then separates the tea leaves from the brewed tea-based beverage. To aide in the removal of the tea leaves, tea leaves are often packaged in tea bags. The tea bags allow the tea leaves to be easily separated from the brewed tea-based beverage. Such tea bags are typically permeable to liquids. Tea-based beverages may be hot brewed or cold brewed. That is, the water used to brew the tea may be heated to a desired temperature, cooled to a desired temperature or otherwise provided at any temperature.

### BRIEF DESCRIPTION OF DRAWINGS

Various exemplary embodiments of the systems and methods according to this invention will be described in detail, with reference to the following figures, wherein:

FIG. 1 illustrates a tea bag according to an exemplary embodiment that has been submerged in a container of water;

FIG. 2 illustrates the tea bag of FIG. 1 after it has been submerged in the container of water for a first period of time;

FIG. 3 illustrates the tea bag of FIG. 1 removed from the container of water after having been submerged for the first period of time;

FIG. 4 illustrates a container according to an exemplary embodiment of the invention; and

FIG. 5 illustrates the container of FIG. 4 as viewed along the line 5-5 shown in FIG. 4.

### DETAILED DESCRIPTION OF DISCLOSED EMBODIMENTS

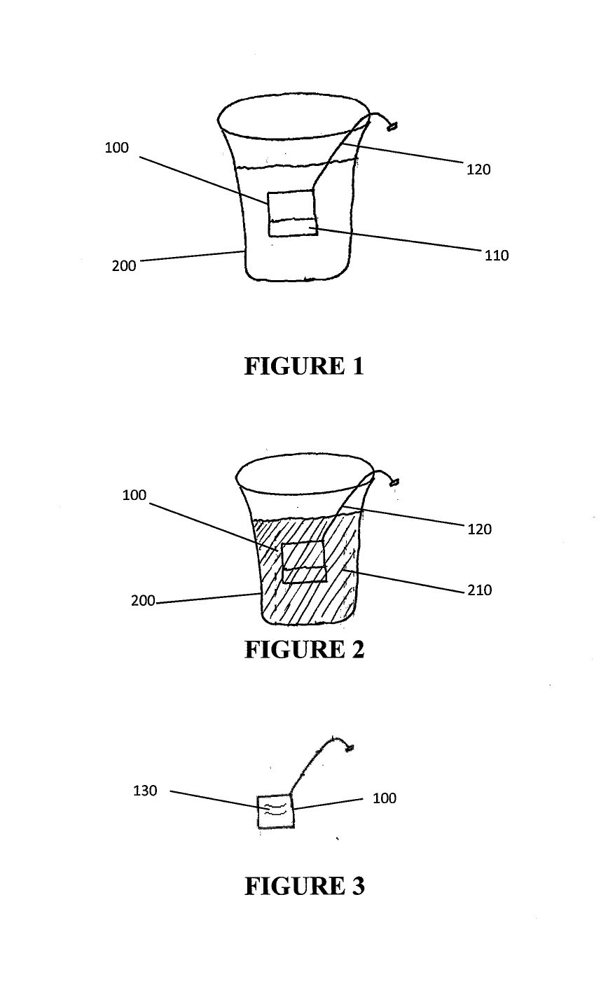

FIG. 1 shows a tea bag 100 according to an exemplary embodiment of this invention. In FIG. 1, the tea bag 100 has been submerged in a container of water 200. The tea bag 100 contains an amount of tea leaves 110 usable to brew a desired tea-based beverage. It should be appreciated that the tea leaves 110 may be black tea leaves, white tea leaves, green tea leaves, or any other desired variety of tea leaves. Additionally, it should be appreciated that other objects, such as spices, herb leaves, artificial flavorants, natural flavorants, natural sweeteners, artificial sweeteners, coloring agents, preservatives, or the like, may be included within the tea bag 100. In general, any object that desirably affects the brewing of the tea-based beverage (e.g., by changing the flavor, color, shelf life, or other quality of the tea-based beverage) may be placed in the tea bag 100.

In various exemplary embodiments, the tea bag 100 will also include a string 120. The string 120 may be used to facilitate the removal of the tea bag 100 from the container 200. For example, in various embodiments, when the tea bag 100 is submerged in the container of water 200, at least a portion of the string 120 remains outside of the container of water 200 such that a user can pull the string 120 to remove the tea bag 100 from the container of water 200.

As shown in FIG. 1, the tea bag 100 has been submerged in the container of water 200. The container of water 200 may be a pitcher, a pot, a glass, a cup, a mug, a French press, a kettle, or any other known or later developed vessel usable to contain an amount of liquid. The tea bag 100 is submerged according to known methods in the art. While submerged, the tea bag 100 interacts with the water in the container of water 200 to generate a tea-based beverage. It should be appreciated that the process by which the tea bag 100 interacts with the water may be any known or later developed process. In general this process is referred to as brewing.

It should be appreciated that the container of water 200 may be replaced with a container of any other desirable substance. For example, in various exemplary embodiments, the container of water 200 may be replaced by a pitcher of lemonade, or any other desirable beverage to create a different desired tea-based beverage.

As shown in FIG. 2, after the tea bag 100 has been submerged in the container of water 200 for a first desired period of time, the tea leaves 110 in the tea bag have helped infuse the water in the container of water 200 to create a tea-based beverage 210. It should be appreciated that the length of time necessary to create the tea-based beverage 210 may vary based any number of factors. For example, the user's taste preferences may affect the length of time (e.g., leaving the tea bag 100 in the container of water 200 for a longer period of time to create a stronger tea flavor), the temperature of the water, the type of tea, the permeability of the tea bag 100, or any other desirable characteristic.

FIG. 3 shows the tea bag 100 after it has been removed from the container of water 200. It should be appreciated that the tea bag 100 may be removed after any desired time period. Typically, the desired time period will be long enough to create the desired tea based beverage 210. For example, the tea bag 100 may be removed after two minutes, after five minutes, or after the user has tasted the tea-based beverage 210 and determined that the flavor is appropriate.

As shown in FIG. 3, after the tea bag 100 has been removed from the container of water 200, a previously unseen indicia 130 is visible. The indicia 130 may be a figure, logo, design, phrase, slogan, or any other desired message or image. In various exemplary embodiments, the indicia 130 is a fortune.

It should be appreciated that the tea bag 100 may have indicia on its surface prior to being submerged in the container of water. That is, the tea bag 100 may have a logo, product name, or other desirable indicia on its surface. When the tea bag 100 is placed in the container of water, the indicia on the surface of the tea bag may change. For example, in various exemplary embodiments, additional indicia, such as the indicia 130, becomes visible on the surface of the tea bag 100 after the tea bag 100 has been submerged in the container of water 200. In various other exemplary embodiments, at least a portion of the first indicia is blocked, removed, altered, faded, or otherwise changed to change the appearance of the indicia 130 visible after the brewing process. In various other exemplary embodiments, additional indicia 130 becomes visible.

It should be appreciated that the change in the indicia may occur in a variety of different ways. In various exemplary embodiments, heat sensitive ink is used on the tea bag to provide the first (e.g., original) and or second (e.g., previously unseen) indicia. In various ones of these exemplary embodiments, the first indicia becomes obscured or altered after the temperature of the tea bag is raised or lowered to a first level. In various other exemplary embodiments, the second indicia becomes visible when the temperature of the tea bag is raised or lowered to a desired level. In yet other exemplary embodiments, at least a portion of the first indicia becomes obscured while at least a portions of the second indicia becomes visible.

Additionally, in various exemplary embodiments, the tea bag 100 may contain a water soluble layer or substance on at least one surface of the tea bag 100. In such exemplary embodiments, when the tea bag 100 is submerged in the container of water 200, the water soluble layer dissolves, thins, becomes transparent or translucent, or is otherwise removed. In various ones of these exemplary embodiments, the previously unseen indicia 130 is provided behind the water soluble layer and is at least partially visually obscured by the water soluble layer. As such, when the water soluble layer is dissolved, thinned, becomes transparent or translucent, or is otherwise removed, the previously unseen indicia 130 becomes visible.

It should be appreciated that the previously unseen indicia 130 may be visible before removing the tea bag 100 from the container of water 200. For example, if the tea-based beverage 210 is sufficiently translucent, the tea bag 100 and the indicia 130 may be visible while the tea bag 100 is still submerged in the container of water 200.

It should also be appreciated that the previously unseen indicia 130 may be usable to provide particular information to the user. For example, in various exemplary embodiments the previously unseen indicia 130 may be provided in a manner such that it becomes visible when the tea-based beverage 210 has been sufficiently brewed and thus is ready for consumption. In various ones of these exemplary embodiments, the previously unseen indicia 130 may become visible after a predetermined time period has elapsed, after the tea bag 100 has reached a desired temperature (e.g., by raising or lowering the temperature), or based on any other measurable factor.

It should also be appreciated that in various exemplary embodiments the previously unseen indicia 130 may be a set of indicia that becomes visible at different times. For example, the set of indicia may include a first indicia that appears after a first time period and indicates to the user that the tea-based beverage 210 has been sufficiently brewed for a mild or weak tea-flavor; a second indicia that appears after a longer time period and indicates that the tea-based beverage 210 has been sufficiently brewed for a normal or typical tea-flavor; and a third indicia that appears after a third time period and indicates that the tea-based beverage has been sufficiently brewed for a strong flavor.

It should also be appreciated that in various exemplary embodiments various methods of obscuring and revealing the indicia 130 may be used in combination to provide multiple ones of the set of indicia. For example, in various exemplary embodiments, a first indicia may be provided with a water sensitive ink such that the first indicia becomes visible after the tea bag 100 has been sufficiently moistened.

Likewise, in various exemplary embodiments, different indicia may be revealed depending on the method of making the tea-based beverage 210. For example, in various exemplary embodiments, the tea bag 100 may include two sets of indicia provided with different temperature reactive ink. In various ones of these exemplary embodiments, a first set of the indicia may become visible if the tea bag 100 is brewed in a container of water 200 that contains a hot liquid; while a second set of indicia becomes visible if the tea bag 100 is brewed in a container of water 200 that contains a cold liquid.

It should be appreciated that any of the above-outlined and other embodiments of the invention may be used in any conceivable combination.

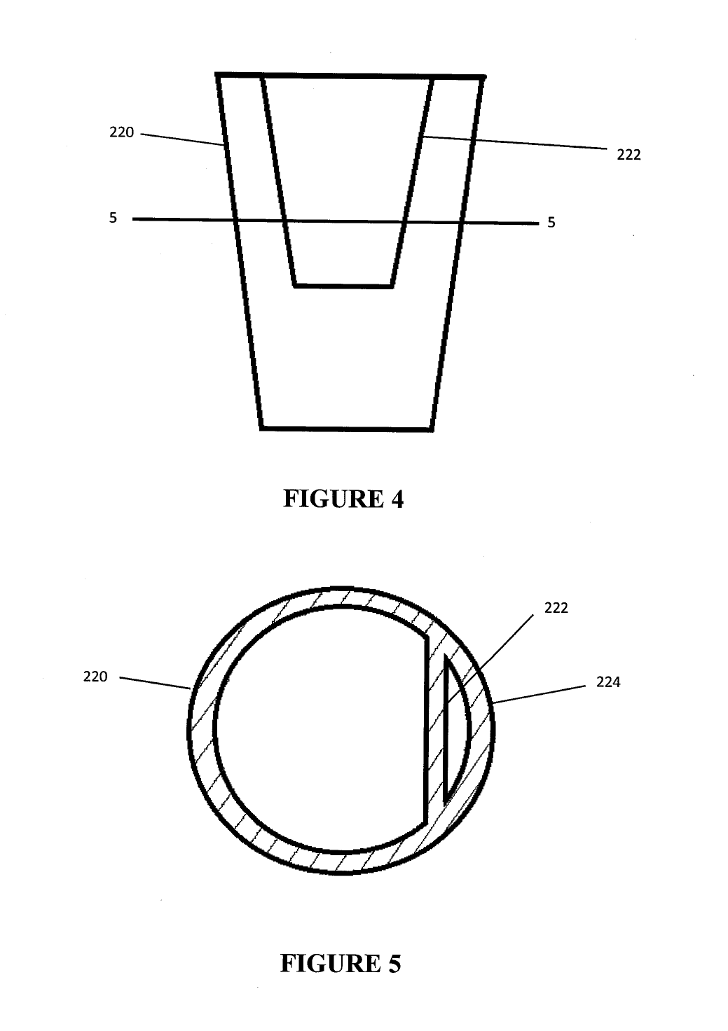

FIG. 4 shows an exemplary embodiment of a container 220, which may be usable in place of or in addition to the container of water 200 shown in FIGS. 1 and 2. As shown in FIG. 4, in various exemplary embodiments, the container 220 includes an interior pocket 222. It should be appreciated that the pocket 222 may be a partial interior void, a vessel, an armature, a cage or any other interior structure usable to contain the tea bag 100 (shown in FIGS. 1-3). In various exemplary embodiments, the pocket 222 is a projection extending upward from an interior surface of the container 220.

The pocket 222 is at least semi-permeable to liquids. That is, water or other liquids placed in the container 220 will be able to interact with the tea bag 100 when placed in the pocket 222. As such, when the tea bag 100 is placed in the pocket 222 the container 220 is usable to brew a tea-based beverage. It should be appreciated that the pocket 222 may include apertures, holes, slots, or any other structure that allows water or other liquids to penetrate the tea bag 100 when it is placed in the pocket 222. For example, in various exemplary embodiments, the pocket 222 is a partial cage provided on the interior of the container 220. In various other exemplary embodiments, the pocket 22 is a bracket having at least one open side such that liquids placed in the container 220 can interact with the tea bag 100 when placed in the pocket 222. In various other exemplary embodiments, the pocket 222 may be a clip, a hook, a clamp or some other known or later developed structure usable to secure the tea bag 100 to an approximate location in the interior of the container 220.

As shown in FIG. 5, in various exemplary embodiments, at least a portion of the container has a convex outer surface usable as a lens 224. In various exemplary embodiments, the lens 224 assists a user in viewing the tea bag 100 and/or the indicia 130 that appears on the tea bag 100. It should be appreciated that the lens 224 may be provided on a container 222 without a concave outer surface. For example, a lens may be imbedded in a wall of the container 222, or the wall of the container may be composed of materials that act as a lens without need for a concave outer surface. Likewise, the interior surface of the container 200 in the area around the pocket 222 may be manipulate or formed in a manner to provide the lens 224.

It should be appreciated that in various exemplary embodiments, the shape of the pocket 222 and the shape of the lens 224 are not necessarily related. That is the pocket 222 may be shaped in a manner to at least partially contain the tea bag 100 while the lens 224 may be shaped in a manner to draw attention to, clarify, magnify, or otherwise alter the appearance of the indicia 130.

1. A tea bag comprising:
an amount of tea leaves encased in a water permeable membrane; and
a string attached to the water permeable membrane;
wherein the water permeable membrane is usable to contain the amount of tea leaves when the tea bag is placed in a liquid; and
wherein a first indicia provided on the water permeable membrane becomes changes appearance when the tea bag has been submerged in a desired liquid for a desired period of time.

2. The tea bag of claim 1, wherein the first indicia is provided on the water permeable membrane and is visible before submerging the tea bag in the desired liquid but is substantially not visible after the tea bag has been submerged in the desired liquid for the desired period of time.

3. The tea bag of claim 1, wherein the first indicia comprises heat sensitive ink and the desired liquid is provided at a desired temperature such that the first indicia changes appearance when exposed to the desired liquid for the first desired period of time.

4. The tea bag of claim 1, wherein the tea bag further comprises a water soluble surface that substantially obscures the first indicia before the tea bag is submerged in the desired liquid and does not obscure the first indicia when the tea bag has been submerged in the desired liquid for the first desired time period.

5. The tea bag of claim 1, wherein the tea bag further comprises a second indicia that changes appearance when the tea bag has been submerged in the desired liquid for the first desired time period.

6. The tea bag of claim 5, wherein the second indicia is substantially obscured by the first indicia before the tea bag is submerged in the desired liquid and is substantially unobscured when the tea bag has been submerged in the desired liquid for the first desired time period.

7. The tea bag of claim 1, wherein the first indicia comprises a series of sub-indicia that are not visible before the tea bag is submerged in the desired liquid and become visible at different time periods after the tea bag has been submerged in the desired liquid.

8. The tea bag of claim 1, wherein the first indicia is usable to convey information to a user.

9. A method of brewing tea comprising the steps of:
placing a tea bag in a desired liquid;
observing the tea bag in the desired liquid;
removing the tea bag from the desired liquid when a first indicia becomes visible on a surface of the tea bag.

10. The method of claim 9, wherein the step of removing the tea bag comprises determining that the tea bag has reached a first desired temperature base on the appearance of the first indicia.

11. The method of claim 9, wherein the step of observing the tea bag in the desired liquid comprises observing a surface of the tea bag and determining the condition of a first indicia on the surface.

12. The method of claim 9, wherein removing the tea bag from the desired liquid comprises observing a first indicia on a surface of the tea bag and determining an elapsed time since the tea bag was placed in the desired liquid based on an appearance of the first indicia.

13. The method of claim 12, wherein removing the tea bag from the desired liquid further comprises observing changes in the appearance of the first indicia that correspond to the elapsed time and determining that a first desired time period has elapsed based on the appearance of the first indicia.

14. The method of claim 9, wherein removing the tea bag from the desired liquid comprises observing a first indicia on a surface of the tea bag and determining a relative strength of a brewed beverage based on an appearance of the first indicia.

15. A container for brewing desired beverages comprising:
a vessel usable to contain a desired volume of a desired liquid, wherein the vessel comprises:
a side wall having an interior surface and an exterior surface; and
a floor attached to the side wall;
wherein the side wall and the floor define an interior volume and an open mouth of the vessel; and
a pocket attached to the interior surface of the side wall of the vessel, the pocket usable to contain a brewing device;
wherein the brewing device is visible through the side wall of the vessel when placed on the pocket.

16. The container of claim 15, wherein the pocket is permeable to the desired liquid such that brewing device is exposed to the desired liquid when the brewing device is placed in the pocket and the vessel is filled with the desired liquid.

17. The container of claim 15, wherein the side wall of the vessel is configured to provide a magnifying effect such that indicia provided on the brewing device are magnified when viewed through the side wall of the vessel.

18. The container of claim 15, wherein the pocket comprises a grid-shaped support structure attached to the side wall and capable of supporting the brewing device.

19. The container of claim 15, wherein the pocket is configured to hold the brewing device against the side wall of the vessel such that a first surface of the brewing device is adjacent to, and visible through, the side wall of the vessel.

20. The container of clam 19, wherein the brewing device is substantially unobscured by the presence of the desired liquid in the vessel.
